(19) United States
(12) Patent Application Publication
(10) Pub. No.: US 2016/0136671 A1
(43) Pub. Date: May 19, 2016

(54) AGRICULTURAL PRODUCT DELIVERY CONTROL IN AN AGRICULTURAL SPRAYER

(71) Applicants: Jared KOCER, Sioux Falls, SD (US); John PREHEIM, Beresford, SD (US); Nick BOWERS, Sioux Falls, SD (US)

(72) Inventors: Jared Ernest Kocer, Sioux Falls, SD (US); John D. Preheim, Beresford, SD (US); Nick Bowers, Sioux Falls, SD (US)

(21) Appl. No.: 14/899,946

(22) PCT Filed: Jun. 24, 2014
(86) PCT No.: PCT/US2014/043926

§ 371 Date: Dec. 18, 2015

Related U.S. Application Data
(60) Provisional application No. 61/838,672, filed on Jun. 24, 2013.

(51) Int. Cl. B05B 12/00; B05B 1/20; G05B 15/02; B05B 13/00; A01C 15/00; G05D 7/06

(52) U.S. Cl. CPC B05B 12/00; A01C 15/003; G05D 7/0676; G05B 15/02; B05B 13/005; B05B 1/20

(57) ABSTRACT

A method for controlling a delivery of an agricultural product includes measuring an agricultural product flow rate. The method includes inputting a system target flow rate for an agricultural product delivery system and controlling an agricultural product pressure to approach the system target flow rate. An agricultural product system target pressure corresponding to the system target flow rate based on at least one system pressure characteristic is provided. The agricultural product system target pressure is compared with a measured agricultural product system pressure in a pressure comparison to provide a pressure difference and a system pressure is adjusted according to the pressure difference to approach the agricultural product system target pressure.

### CLAIM OF PRIORITY

This application claims the benefit of U.S. Patent Application Ser. No. 61/838,672, filed on Jun. 24, 2013, the benefit of priority of which is claimed hereby, and which is incorporated herein by reference in its entirety.

### CROSS-REFERENCE TO RELATED PATENT DOCUMENTS

This patent application is also related to U.S. application Ser. No. 13/832,735 filed on Mar. 15, 2013, entitled MULTI-SECTION APPLICATOR WITH VARIABLE-RATE SECTIONS.

This patent application is also related to U.S. application Ser. No. 13/832,678 filed on Mar. 15, 2013, entitled REAL TIME INJECTION FOR AGRICULTURAL SPRAYERS.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S. Dak.; All Rights Reserved.

### TECHNICAL FIELD

This document pertains generally, but not by way of limitation, to the application of products and supplementing of the products.

### BACKGROUND

Agricultural sprayers are used to distribute agricultural products, such as fertilizers, insecticides, herbicides and fungicides to crops. Agricultural sprayers include one or more distribution booms that are long enough (e.g., 60 feet to 150 feet) to spray multiple rows of crops in a single pass. Agricultural fields are often irregular in shape and contain one or more of contour changes tree lines, hillsides, ponds, or streams. Irregular shapes or contour changes can provide challenges in even distribution of agricultural products and can lead to waste of the product. Additionally, the configuration of the agricultural sprayer itself may cause unpredicdatabase variation in application of the agricultural product.

Agricultural sprayers include a reservoir for a carrier substance. The reservoir is in communication, by way of a header tube or pipe, with a plurality of sections provided along one or more carrier booms (e.g., boom tubes along the booms). The header is the main line extending between the reservoir and the carrier booms. Each of the plurality of sections includes multiple sprayer nozzles that distribute the carrier substance received by the section. The carrier substance is used as a vehicle to carry and distribute one or more injection products dispersed into the carrier substance, for instance herbicides, pesticides, fertilizers or the like.

In one example, the injection product is retained in a reservoir separate from the reservoir for the carrier substance. The injection product is pumped from the reservoir and delivered from the reservoir to the header of the carrier substance. In some examples, an inline mixer (e.g., a static mixer) mixes the injected chemical with the carrier substance upstream from or within the header. The header then delivers the mixture to the boom tubes, and the mixture is then distributed to the sections and finally the nozzles associated with each of the sections.

### OVERVIEW

The present inventors have recognized, among other things, that a problem to be solved can include controlling delivery of an agricultural product at low flow rates. In an example, the present subject matter can provide a solution to this problem, such as by providing a pressure based control system to control delivery of an agricultural product to an agricultural field. The accuracy or controllability of the pressure based control system can be substantially unaffected by flow rates, such as low flow rates.

The present inventors have recognized, among other things, that a problem to be solved can include manual or user based control scheme alteration during operation of a vehicle. In an example, the present subject matter can provide a solution to this problem, such as by providing an automated overall control configuration configured to switch between at least two modes of agricultural product delivery flow control operations, including, but not limited to, flow based and pressure based. The automated overall control configuration automatically switches between the multiple control configurations based on a number of factors, such as flow rate, agricultural product pressure, geographical location, agricultural product type, mechanical failures, user input, stored historical information, measured or determined control events, and combinations thereof.

The present inventors have recognized, among other things, that a problem to be solved can include minimizing operator interaction (automating) calibration of an agricultural product dispensing system (optionally the control system for the same). In an example, the present subject matter can provide a solution to this problem, such as providing a historical calibration database associating a variety of parameters to one or more of a specific agricultural product or product dispenser (e.g., nozzle, boom, sprayer, granular spreader, or the like). Parameters include, but are not limited to, flow rates, pressures, error indicators, pressure to flow rate ratio, geographical factors, seasonal factors, effective nozzle orifice parameters, and combinations thereof. The historical calibration database includes, but is not limited to, one or more of nozzle profiles, including one or more of the name of the nozzle, the nozzle size, effective nozzle orifice parameters, the type of agricultural product, an agricultural product characteristic, such as viscosity, or input pressure and corresponding actual flow rates. Effective nozzle orifice parameters include any parameter that affects the size of the orifice of the nozzle assembly for dispensing the agricultural product, including, but not limited to, expected fouling, agricultural product characteristics, operating temperature, or the like. The historical calibration database is used (e.g., as a periodically or constantly updated look up database) to increase the accuracy of the control scheme for delivering the agricultural product.

The present inventors have recognized, among other things, that a problem to be solved can include agricultural delivery error detection during delivery of an agricultural product and limiting or eliminating such errors. In an example, the present subject matter can provide a solution to this problem, such as by providing a historical lookup database relating a number of control parameters, such as pressure, flow rate, and back pressure, to indicate at a general or specific delivery error. A general delivery error indication includes an indication that the system is not operating correctly. Specific delivery error indications include nozzle fouling, tube rupture, pump failure, sensor failure, or a combination thereof. The historical lookup database provides a periodically or constantly updated database of values usable in combination with flow or pressure based control to ensure accurate dispensing of a product even with detected errors or failures in a dispensing system (e.g., fouled nozzles or the like). Alternatively, the historical lookup database is selectively used alone in an open loop control scheme to accurately control the dispensing of a product.

The present inventors have recognized, among other things, that a problem to be solved can include boom, row, or section control of an agricultural delivery system. In an example, the present subject matter can provide a solution to this problem, such as by providing greater control to individual sections or rows of an agricultural product delivery system by a control scheme for delivering an agricultural product configured through flow rate control or flow rate control as a function of pressure based control of the agricultural product in each individual section or row of the agricultural delivery system.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

The drawings, which are not necessarily drawn to scale, illustrate generally, by way of example, but not by way of limitation, various embodiments discussed in the present document.

FIG. 1 is a perspective view of one example of an agricultural sprayer.

FIG. 2 is a top view of one example of an agricultural sprayer and an agricultural field.

FIG. 3 is a control flow diagram of one example of an agricultural sprayer control system including flow and pressure control.

FIG. 4 is a detailed schematic view of one example of an agricultural sprayer control system including a flow control loop and a pressure based flow control loop.

FIG. 5 is a block diagram showing one example of a method for controlling delivery of an agricultural product.

FIG. 6 is a block diagram showing one example of a method for performing diagnostics of an agricultural product delivery system.

FIG. 7 is a block diagram showing one example of a method for calibrating an agricultural product delivery control system.

FIG. 8 is a block diagram showing one example of a method for controlling delivery of an agricultural product.

### DETAILED DESCRIPTION

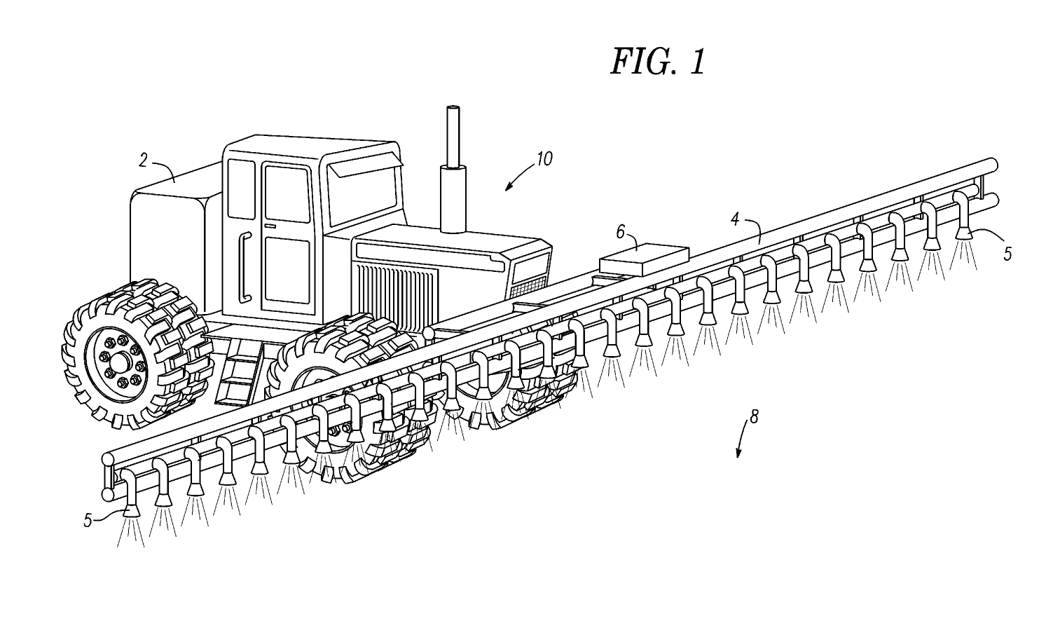

As illustrated in FIG. 1, an agricultural sprayer 10 includes a reservoir tank 2, one or more sprayer booms 4, including one or more sprayer assemblies 5, and a controller 6. In an example, the agricultural sprayer 10 includes an integral reservoir tank 2 or a tow behind reservoir tank. The reservoir tank 2, in an example, includes the agricultural product mixed with a carrier fluid, such as water, or the carrier fluid and the agricultural product are mixed in-line prior to or at the sprayer boom 4. The sprayer assemblies 5 are positioned along the sprayer boom 4 to deliver the agricultural product to a crop or an agricultural field 8. Crops include, but are not limited to, any product grown in an agricultural field, such as row and non-row based crops. Agricultural products include, but are not limited to, fertilizers, water, pesticides, fungicides, herbicides, or the like. As shown, the agricultural sprayer 10 includes controller 6, as described herein. The controller 6, as will be discussed herein, controls delivery of the agricultural product from the reservoir tank 2, to the sprayer boom 4 and the associated sprayer assemblies 5 for delivery to the agricultural field or crop.

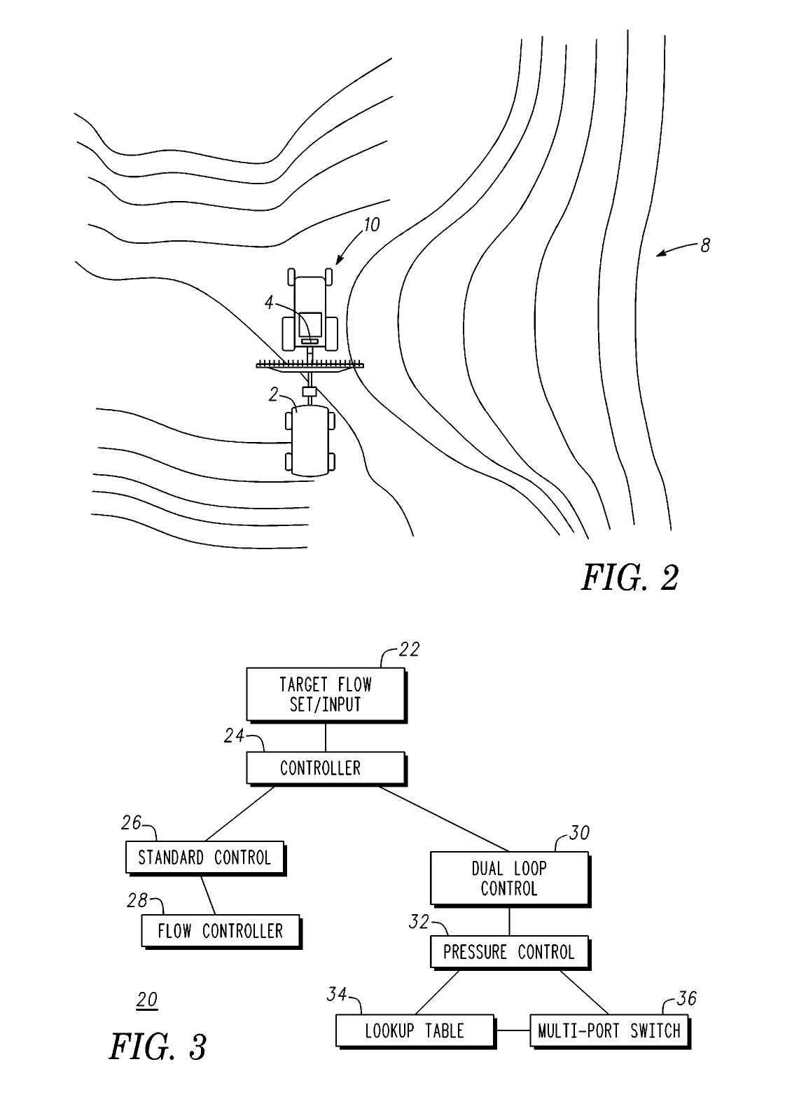

As illustrated in FIG. 2, an example of an agricultural sprayer 10 is provided in an agricultural field 8 and delivering an agricultural product. The agricultural sprayer 10 includes a tow behind reservoir tank 2, one or more sprayer booms 4 (e.g., dual booms extending from the center of the sprayer 10), and the controller 6. As described herein, the controller 6 controls delivery of the agricultural product to the agricultural field 8 or crops.

FIG. 3 shows a general control flow diagram 20, according to an embodiment. For example, a target flow rate is set or input into the controller at an input module 22, such as by a user or program. The target flow rate includes a specified flow rate of agricultural product or a flow rate of a mixture of the agricultural product and the carrier fluid. In one example, the specified flow rate includes a plurality of flow rates for a variety of conditions. For instance, the controller uses one or more of the flow rates for varying field conditions, field map prescriptions or the like. The target flow rate from the input module 22 is received by the controller 24, such as a central electronic control unit (ECU). The ECU, in an example, controls agricultural product delivery to one or more of the sprayer boom 4, a boom section of a sprayer boom, or each of the nozzle assemblies located thereon. The controller 24, as described herein, is configured to control delivery of the agricultural product by two methods: as shown with a standard control module 26 and a cascade control module 30. Generally, the standard control loop module 26 controls a flow rate of the agricultural product relative to the set target flow rate, such as by a flow controller module 28. The cascade control module 30 uses a pressure controller 32 to control a pressure of the agricultural product (e.g., a system pressure of the overall sprayer system or a portion of the system such as a section of the boom and the corresponding nozzle assemblies) and thereby control the flow rate of the agricultural product. The pressure controller 32, in an example, relates the pressure of the agricultural product to a flow rate by a lookup database 34 and an optional multi-port switch 36. The controller 24, in an example, automatically switches between the standard control 26 and the cascade control 30 (e.g., at a flow threshold). In another example, a user manually switches between the standard control and the cascade control methods (and accordingly the standard control module 26 and the cascade control module 30).

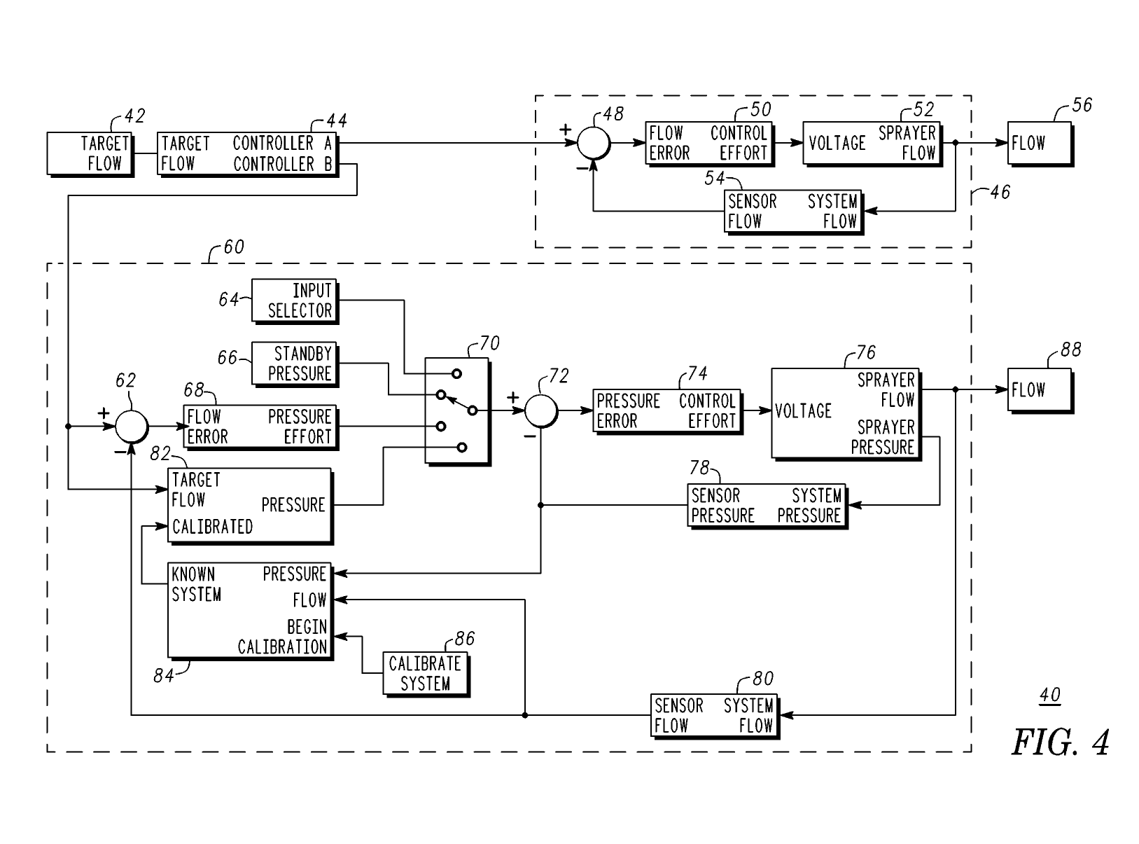

FIG. 4 illustrates a detailed schematic view of one example of an agricultural sprayer control system 40 including flow control and pressure based flow control. At the input module 42, a system target flow rate is entered by a user or by the control system 40 (e.g., based on prescribed sprayer flow rates, for instance from a field map). The system target flow rate, in one example, includes a volume of agricultural product per time or a volume of agricultural product per area (e.g., acre, square foot, or the like). The controller 44 (e.g., an electronic control unit (ECU)) receives the system target flow rate from the input module 42 and selects the standard loop control module 46 or the cascade control module 60. In an example, the controller 44 selects the control loop modules 46, 60 based on the system target flow rate 42 relative to a specified threshold flow rate. For example, if the system target flow rate is below the specified threshold flow rate (e.g., 10 gpm) the cascade control module 60 (pressure based flow control) is used to ensure accurate control is achieved at the lower flow rates. The specified threshold flow rate, in an example, is the minimum flow rate rating for a flow meter, as described herein. The minimum flow rating for a flow meter includes the lowest flow rate at which the flow meter is capable of accurately providing the flow rate of the agricultural product. For example, the minimum flow rate includes, but is not limited to, one or more of about a 90% measuring accuracy, about a 95% measuring accuracy, about a 98% measuring accuracy, about a 99% measuring accuracy or about 99.5% or higher measuring accuracy. The minimum flow rate includes, but is not limited to, in various examples, about 20 gpm, about 15 gpm, about 10 gpm, about 7 gpm, about 5 gpm, about 3 gpm, about 2 gpm, about 1 gpm, about 0.5 gpm, or less. In another example, a user selects one of the control loop modules 46, 60 to control the delivery of the agricultural product. In another example, the agricultural sprayer control system 40 uses one of the cascade control module 60 or the standard loop control module 46 when the other of the standard loop and cascade control modules 46, 60 malfunctions, such as due to flow meter error or other mechanical failure.

The standard loop control module 46 includes a flow difference node 48 (e.g., a difference node or comparator), configured to associate and compare a system flow rate at a location 56 of the sprayer system such as a header, sprayer boom 4, boom section, nozzle assembly or the like (e.g., received from flowmeter 54) to the system target flow rate 42. The flow difference node 48 outputs a difference measurement (e.g., error) and delivers the difference measurement (error measurement) to a flow controller 50. The flow controller 50 calculates a corresponding control signal (e.g., voltage adjustment) that results in a pump 52 (valve or general flow controller) altering the flow rate of the agricultural product at the location 56 to approach the system target flow rate. That is, the flow controller 50 sends a signal to the pump 52 (valve or general flow controller) to adjust the agricultural product flow rate 56. In various examples, the pump 52 is an overall system pump upstream of the sprayer boom, such that the pump 52 is configured to adjust the agricultural product flow rate 56 for the entire boom 4 (or booms). In other examples, the pump 52 includes another flow controlling device such as an adjustable valve (e.g., a ball valve or the like).

In another example, the pump 52 is associated with a section of the boom (e.g., a boom section), such that the pump 52 adjusts the agricultural product flow rate of the corresponding section of the boom and its associated nozzle assemblies. That is, the agricultural product flow rate includes an overall system flow rate and a boom section flow rate. For example, the agricultural sprayer control system, in an example, divides the system target flow rate (e.g., from the input module 42) over a plurality of boom sections of the sprayer boom. Each of the boom sections includes an associated pump 52 (valve or general flow controller), flow meter 54, and difference node 48. The system target flow rate in this example is the boom section flow rate transmitted to the respective difference node 48. The flow meter 54 measures the agricultural product flow rate at the location 56 (e.g., the boom section) and sends a corresponding signal to the difference node 48. The standard loop control module 46 thereby continuously (or intermittently at predetermined time intervals) adjusts the system flow rate of the agricultural product (e.g., to correspond to the target flow rate at the input module 42).

Similar to the standard loop control 46, the cascade control 60 includes a flow difference node 62 (e.g., a comparator) configured to associate and compare a system flow rate from a system location 88 such as at a header, sprayer boom 4, boom section, nozzle assembly or the like (e.g., received from flowmeter 80) to the system target flow rate provided at the input module 42to provide a difference measurement (e.g., an error measurement). Although FIG. 4 illustrates each control loop 46, 60 as having separate duplicative components (e.g., difference nodes 48, 62, flow meters 54, 80, and system flow rate locations 56,88) embodiments of the present agricultural delivery system include utilizing the same or separate components between the two control loops 46, 60.

The difference measurement of the flow difference node 62 is provided to a controller 68 (e.g., a controller using fuzzy logic) that generates a target pressure (e.g., a first target pressure or flow error corresponding target pressure) for inputting and use in the cascade control module 60. In an example, the cascade control module 60 includes, in addition to or in place of the first target pressure input, at least one of a pressure input selector module 64 and a standby pressure module 66. For example, when selected, the pressure input selector module 64 allows the user to operate the system in the cascade control module 60 (including instructing a multi-port switch 70 which pressure input and corresponding value to select). The standby pressure module 66 includes a predetermined standby pressure at which the system is maintained during non-operation, such as when the boom is not delivering agricultural product to the agricultural field or crops. At least one of the values from the pressure input selector module 64, the standby pressure module 66, or the controller 68 (e.g., as system pressure characteristics) is provided to a multi-port switch 70 (in an example agricultural sprayer control system 40 including a plurality of system pressure characteristics). The multi-port switch 70 is configured to receive inputs and provide a target pressure (e.g., a second target pressure) to a pressure difference node 72 (e.g., a difference node or comparator). In some examples, the second target pressure corresponds (e.g., is equal) to the first target pressure. The multi-port switch 70 selects the second target pressure based on a predetermined priority (e.g., user programmed), a correlation of some or all the system pressure characteristics (e.g., average), or the like. In an example, the multi-port switch 70 selects the second target pressure from a plurality of system pressure characteristics, including, but not limited to, a user input target pressure received from the input selector module 64, the flow based target pressure (e.g., first target pressure) received from the controller 68, a standby pressure received from the standby pressure module 66, a logged target pressure received from a system lookup module 82, or a combination thereof.

The pressure difference node 72 associates and compares the second target pressure and a measured system pressure, such as from the pressure sensor 78. The pressure sensor 78 measures the system pressure of a section of the sprayer boom, a nozzle assembly, or the entire system and provides the measured system pressure to the pressure difference node 72. In an example, the pressure sensor 78 measures the system pressure at the location 88 that corresponds to at least one of the sprayer boom, a nozzle assembly, or the entire system. The pressure difference node 72 provides the difference (e.g., an error or difference) between the second target pressure and the measured system pressure to a pressure controller 74. The pressure controller 74 includes pressure controllers used in control schemes, such as a proportional-integral-differential (PID) controller. The pressure controller 74 provides a signal, such as a voltage signal, to a pump 76 (valve or controller for the pump) that controls the system flow rate at the location 88 by way of pressure control of the agricultural product. The signal from the pressure controller 74 corresponds to an adjustment to the pump 76 (valve or controller for the pump) to decrease the difference of the measured system pressure and the second target pressure determined by the pressure difference node 72 in a feedback control loop. As described herein, and similarly described here, in an example, the measured system pressure and the second target pressure correspond to a system pressure and target pressure for a portion of the system including, but not limited to, a sprayer boom 4, a boom section, a nozzle assembly, the overall system or the like.

The cascade control module 60 includes a flowmeter 80 configured to measure the system flow rate at the location 88. As described herein, the flowmeter 80 provides the measured system flow rate 88 to the flow difference node 62 and a system database module 84. The measured system flow rate is provided to the flow difference node 62 such that the measured system flow rate is compared to the system target flow rate. The comparison results in a flow difference which is provided to the controller 68. The controller 68 associates the flow difference with a first target pressure (e.g., a flow based target pressure), which is provided to the pressure difference node 72 or, in an example, a multi-port switch 70. As discussed herein, the first target pressure (updated according to measured changes in flow rate with the flow meter 80) is used by the pressure difference node 72 so the pressure difference node 72 provides a signal to the pressure controller 74 to correspondingly adjust the pressure of the pump 76 (valve or controller for the pump) according to these measured changes in flow. Stated another way, the pressure based control of the cascade control module 60 is nested within a flow measuring control loop including the flow meter 80 and the flow difference node 62. The flow and pressure instruments and nodes cooperate to provide pressure based flow control for the dispensing system. As measured flow changes, the pressure control provided with the pressure difference node 72 and the pressure controller 74 (and optionally the controller 68) adjusts the pressure of the system to achieve a desired flow rate (e.g. input at the input module 42).

In an example, such a control system configuration 40 provides the benefit of adjusting the pressure of the agricultural product to approach and achieve a system target pressure. By adjusting the agricultural product pressure, the agricultural sprayer control system 40 operates more accurately at lower system flow rates (e.g., system target flow rates, measured system flow rates), which are below the capabilities of currently available flow meter.

As previously described, in another example the cascade control module 60 includes the system database module 84. The system database module 84 includes inputs from the pressure sensor 78 (e.g., at the location 88), the flowmeter 80 (e.g., the system flow rate 88), and from a calibration node 86. The calibration node 86 is activated when system calibration is desired. For example, the system database module 84 associates the measured system pressure (e.g., from pressure sensor 78) to the measured system flow rate at the location 88. Measurements and associations are repeated at various pressures (e.g., over an operating range or pressures for the system) and measured flow rates to provide a database of pressure-flow rate matches for agricultural sprayer configurations. Agricultural sprayer configurations include, but are not limited to, nozzle profiles, a type of agricultural product, a type of crop, a specific agricultural field, a type of sprayer boom, or the like. As such, the system database module 84 generates accurate pressure-flow rate associations (e.g., matches) for a given agricultural sprayer configuration, for instance corresponding to the unique characteristics or performance of a sprayer system. The known pressure-flow rate matches are provided to a system lookup module 82. The system lookup module 82 associates an input system target flow rate at the input module 42 with the known pressure-flow rate matches from the system database module 84 to provide a target pressure (e.g., a third target pressure) for use with the multi-port switch 70 or the pressure difference node 72. For example, the optional multi-port switch 70 provides the third target pressure provided to the pressure difference node 72.

In an example, the system database module 84 provides the pressure-flow rate associations to the system lookup module 82 based on a pressure-flow association equation. For example, the pressure-flow association equation is used to initially provide the pressure-flow rate associations and are then updated or adjusted based on the measured agricultural product system pressure from the pressure sensor 78 and the measured agricultural product system flow rate from flow meter 80 to provide more accurate pressure-flow rate association. Equation (1) is an example of the pressure-flow association equation includes:

$$Q = {C}_{0} {A}_{0} \sqrt{\frac{2 Δ p / p}{[ 1 - {( {A}_{0} / A )}^{2} ]}} \qquad ( 1 )$$

where: Q is the flow rate of the agricultural product in terms of pressure drop Δp across an orifice of the flow meter 80, the orifice coefficient Cₒ, the orifice area A₀, the pipe cross-sectional area A, and the density ρ of the agricultural product. In an example, Equation (1) can be simplified (e.g., non-turbulent, incompressible flow) and rearranged for application with an agricultural product nozzle (e.g., where A₀/A is zero), such as part of the nozzle assembly 5 in FIG. 1, to provide Equation (2):

$${C}_{f} A = \frac{Q}{\sqrt{\frac{2 Δ p}{ρ}}} \qquad ( 2 )$$

where: C_{f} is a nozzle coefficient and A is the area of the nozzle orifice. In an example, a user can provide a nozzle characteristic or the system has nozzle characteristics for a plurality of difference nozzles. That is, Equation (2) is adjusted for each agricultural product delivery system profile.

The system database module 84 provides a database of accurate pressure-flow rate matches that directly correspond to the unique performance and characteristics of a sprayer system controlled with the control system 40. Because actual combinations of measured system pressures and corresponding flow rates are stored in the system database module 84 reuse of a measured system pressure as the target pressure for a desired flow rate ensures accurate delivery of the agricultural product at the desired flow rate. That is to say, the system database module 84 assesses the actual performance of a unique sprayer system (e.g., having varied lengths and diameters of tubing, elbows, fittings, nozzle profiles or the like) with pressure-flow rate matches, stores the matches in the system lookup module 82, and then uses those matches (through the system lookup module 82) in combination with a desired target flow rate to readily achieve the desired flow rate at the location 88. As described herein, a pressure value from the matches of the system lookup module 82 (corresponding to a target flow rate) is used with the cascade control module 60 including the pressure difference node 72 and the pressure controller 74 to accurately provide the desired target flow rate. After calibration and storage of the pressure-flow rate matches (e.g., for an operating range of pressures and flow rates) measurement of the flow rate, for instance with the flow meter 80, is optional. Instead, measurement of the difference in pressure at the pressure difference node 72 is conducted based on the measured pressure with the pressure sensor 78 and target pressure provided from the database of the system database module 84 to accordingly adjust control of the pump 76 (valve or pump controller) to achieve the desired target flow rate.

In an example, the multi-port switch 70 is configured to provide at a second target pressure based on at least one system pressure characteristic to the pressure difference node 72 (e.g., difference node or comparator). The at least one system pressure characteristic includes the first target pressure (from the controller 68), the logged target pressure (from the system lookup module 82), the standby pressure (from the standby pressure module 66), the user input target pressure (from the input selector module 64), or a combination thereof (e.g., average, weight average, or the like). Stated another way, the control system 40 automatically (or at the direction of an operator) is able to switch between these system pressure characteristics and accordingly provide the corresponding values (target pressures) for use with the pressure difference node 72. The multi-port switch 70 provides the second target pressure based on a predetermined priority (e.g., user programmed), a correlation of some or all the system pressure characteristics (e.g., average), or the like.

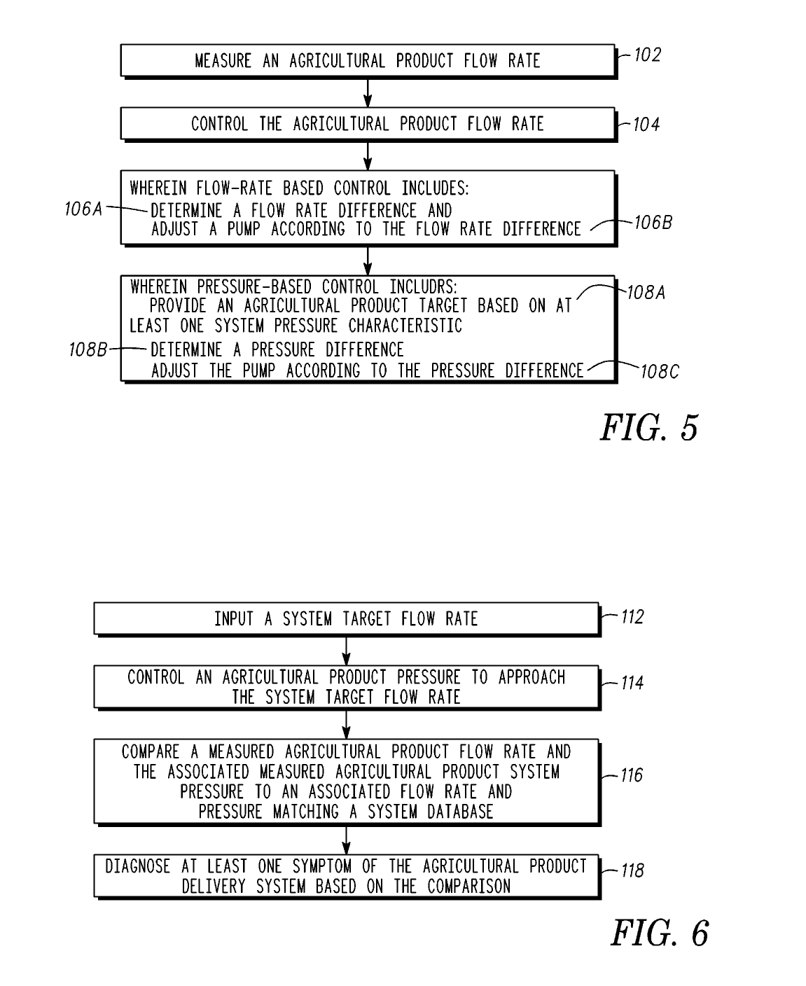

FIG. 5 illustrates a method 100 for controlling delivery of an agricultural product. The method 100 includes measuring an agricultural product flow rate, at 102. For example, the agricultural product flow rate (e.g., at locations 56, 88) is measured by at least one of flowmeters 54, 80 (or the same flowmeter). At 104, the method 100 includes controlling the agricultural product flow rate. The controller (e.g., 44) is configured to control the agricultural product flow rate to selectively provide both of flow rate-based control and pressure-based control of flow rate to achieve a system target flow rate. Flow rate-based control includes the standard loop control module 46, as shown in FIG. 4 and described herein. Pressure-based flow control is shown in one example with the cascade control module 60 as shown in FIG. 4 and described herein.

In an example, the method 100 includes controlling the agricultural product flow rate according to flow rate-based control when the measured agricultural product flow rate meets or exceeds a specified threshold flow rate. The specified threshold flow rate, in an example, is the minimum flow rate rating for the flow meter (e.g., the flow meter 54, 80 associated with a sprayer boom, boom section, nozzle assembly, or the like). At 106A, the method 100 includes determining a flow rate comparison (difference), such as, for example comparing the measured agricultural product flow rate with a system target flow rate in a flow rate comparison to determine a flow rate difference. In an example, the method 100 includes determining the system target flow rate from a system acreage flow rate input based on at least one of a speed of a sprayer boom, a width of the sprayer boom, an agricultural sprayer vehicle speed, a yaw rate of the sprayer boom, and the system acreage flow rate. Conducting the flow rate comparison is performed, in an example, at a difference node, such as the flow difference node 48 shown in FIG. 4. At 106B, the method 100 includes adjusting a pump (e.g., a valve or flow rate controller) according to the flow rate difference to approach the system target flow rate. For example, adjusting the pump (valve or flow controller) at 106B is performed by a pump 52 of FIG. 4. Adjusting the pump 106B includes increasing or decreasing the flow rate of the pump so as to approach the system target flow.

The method 100 includes controlling the agricultural product flow rate by pressure-based flow control (e.g., with the cascade control module 60). At 108A, the method includes providing an agricultural product target pressure based on at least one system pressure characteristic. The at least one system pressure characteristic includes, but is not limited to, an input target pressure (e.g., from the input selector module 64, FIG. 4), a standby pressure (e.g., from the standby pressure module 66, FIG. 4), a flow difference corresponding target pressure (e.g., from the controller 68, FIG. 4), a logged target pressure (e.g., from the system lookup module 82, FIG. 4), or combinations thereof.

In an example, the at least one system pressure characteristic includes a flow based target pressure based on the flow rate difference. For instance, the flow based target pressure value is provided by the controller 68 based on the difference in flow rates measured at the flow difference node 62. The method 100 includes comparing the agricultural product target pressure with a measured agricultural product system pressure (e.g., measured with the pressure sensor 78 in FIG. 4) in a pressure comparison to determine a pressure difference, at 108B (e.g., with the pressure difference node 72, FIG. 4). At 108C, a pressure controller, such as the pump in FIG. 4 (e.g., pump 52, 80, a valve or pump controller), is adjusted according to the pressure difference to approach the system target flow rate (e.g., 42, FIG. 4). As described herein the pressure based portion of the cascade control module 60 (e.g., the pressure difference node 72, the pressure controller 74 and the like) is nested with the flow measurement and comparison features of the module 60 (e.g., the flow difference node 62 and controller 68). Accordingly, with flow based inputs (e.g., a target flow rate) pressure control is provided for the pump 52 (or other component such as a valve) to ensure accurate and reliable dispensing at a desired flow rate. The nested system of the cascade control module 60 ensures dispensing of the agricultural product at any operational flow rate, including low flow rates that are traditionally hard to control with flow based control systems.

In an example, the method 100 includes providing a system database including a plurality of measured agricultural product system pressures respectively associated with corresponding flow rates for an agricultural sprayer configuration. For example, a measured agricultural product system pressure and flow rate association is recorded in the system database when the system operates at a specified pressure, for a given agricultural sprayer configuration (e.g., with a unique sprayer or a generic sprayer that varies insignificantly), and a corresponding agricultural product flow rate output is measured and associated with the specified pressure. The agricultural sprayer configuration is based at least on one of a width of a sprayer boom, a number of nozzles on the sprayer boom, a type of agricultural product dispersed, a type of agricultural field (e.g., soil, topology, etc.), a type of nozzle on the sprayer boom (e.g., orifice size, flow characteristic, or the like), and a type of crop the agricultural product is deliver to. Stated another way, the agricultural sprayer configuration corresponds to one or more of the unique characteristics of an agricultural product sprayer system, the agricultural product delivered, how it is delivered, or the like. Accordingly, the logged pressure and flow rate associations are based on the unique sprayer system and therefore reproduction of a pressure from the database will result in the corresponding associated flow rate. The method 100 includes logging a target pressure and an associated corresponding flow rate in the system database where the measured agricultural product flow rate is substantially equal to the system target flow rate, consequently providing an accurate pressure-flow rate association for the agricultural sprayer configuration. As further described herein, the method 100 includes using the system database to diagnose a fault in an agricultural product control delivery system configured to deliver the agricultural product according to the method.

FIG. 6 illustrates a method 110 for performing diagnostics of an agricultural product delivery system, such as 40, FIG. 4. At 112, the method includes inputting a system target flow rate, such as from a user or pre-programmed instructions. The agriculture product pressure is controlled at 114. Controlling 114 includes providing an agricultural product target pressure based on at least one system pressure characteristic, as described herein in relation to FIGS. 3, 4, and 5. Further, the method 110 includes comparing the agricultural product system target pressure with a measured agricultural product system pressure in a pressure comparison to provide a pressure difference. In an example, the pump is adjusted according to the pressure difference to approach the agricultural product system target pressure, such as taken by pressure sensor 78.

At 116, the method 110 includes comparing a measured agricultural product flow rate and the associated measured agricultural product system pressure to a database match of a flow rate and associated pressure in a system database, for instance the system lookup module 82. In various examples, comparing includes determining a difference between either of the measured pressure and the database pressure (if the flow rates are the same) or the measured flow rate and the database flow (if the pressures are the same). The system database, for example, is part of the system lookup module 82, which is populated by system database module 84. The method 110 includes diagnosing at least one symptom of the agricultural product delivery system based on the comparison of the agricultural flow rate and measured agricultural product pressure to logged flow rate and pressure matches, at 118. The system diagnoses an error (fault or the like), for example, when the determined difference is about 2%, 4%, 6%, 8%, 10%, 20%, 25%, or about 30% or more (e.g., the measured agricultural pressure relative to the system database associated pressure for a flow rate or vice versa for measured and database flow rates for a pressure). The at least one diagnosed symptom includes a general symptom for a specific system, including, but not limited to, at least one of a fouled nozzle, a hose or tube leak, a pump malfunction, a clogged hose or tube or the like. In an example, a user is notified of the diagnosed symptom of the system, such as by a flashing light, audible sound, text prompt display, or a combination therein. In yet another example, the control system conducts one or more ameliorative functions including, but not limited to, the use of another system characteristic (e.g., the flow difference node 62 and the controller 68) or recalibration of the system with the calibration node 86 to account for the diagnosed symptom.

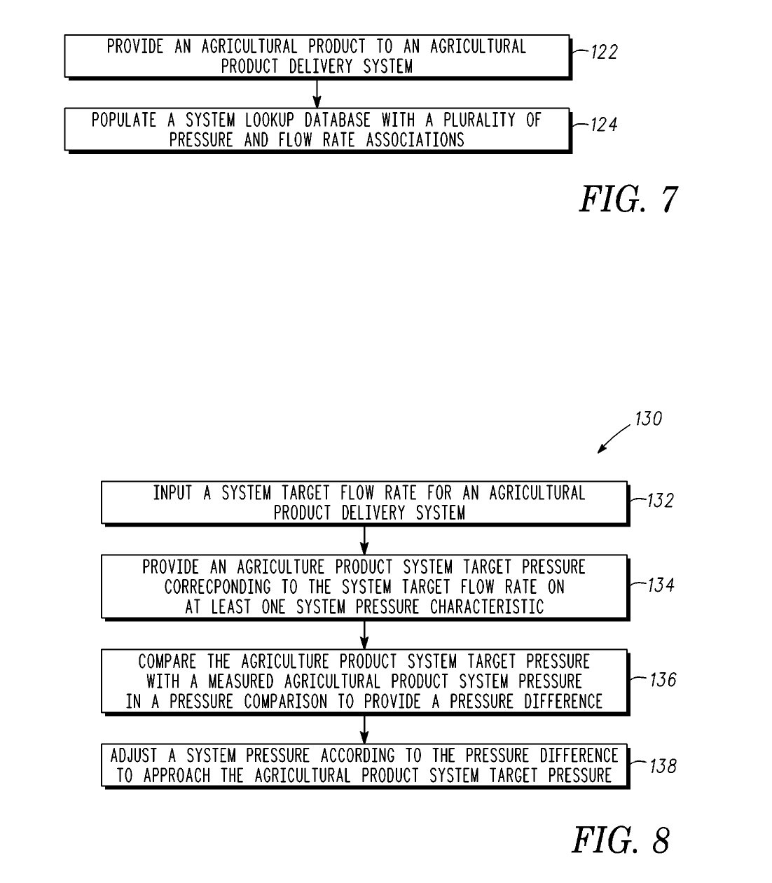

FIG. 7 illustrates a method 120 for calibrating an agricultural product delivery control system, such as the control system 40 shown in FIG. 4. At 122, an agricultural product is provided to an agricultural product delivery system. The agricultural product delivery system, in an example, includes a flow control loop to adjust a flow rate of the agricultural product (e.g., by feedback control) and a pressure based flow control loop configured to operate in place of the flow control loop and adjust a pressure of the agricultural product to control the flow rate of the agricultural product. At 124, the method 120 includes populating a system lookup database, such as with a system database module 84 that associates pressures with flow rates and a system lookup module 82 that stores and shares the associated values (see FIG. 4). Each of the associated pressure and flow rate matches includes at least a specified agricultural product pressure associated with a corresponding measured agricultural product flow rate. The system lookup database is stored in the system lookup module 82 as shown in FIG. 4. For a specified target flow rate, a corresponding specified agricultural product pressure is retrieved from the populated system lookup module 82. In an example, the agricultural product delivery system operates at the specified agricultural product pressure (e.g., through control of a valve, pump or pump controller) to achieve the specified target flow rate.

Optionally, a plurality of system lookup databases are populated in the system lookup module 82. In an example, each database corresponds to an agricultural product delivery system profile. Each of the agricultural product delivery system profile is based on, but is not limited to, at least one of a nozzle profile, (a name of the nozzle model, nozzle size, effective nozzle orifice parameters or the like), an agricultural product characteristic (including at least one of viscosity, density, concentration, and porosity), the characteristics of the sprayer system including tubing diameters, elbow configurations, fittings or the like that all affect pressure and flow relationships. During calibration, the measured pressure and associated flow rates are logged (e.g., at a series of specified pressures) for the agricultural product delivery system profile. Stated another way, calibration is conducted according to the unique characteristics of the sprayer system being calibrated. The control system 40 readily selects another agricultural product delivery system profile, for instance when installed with a differing sprayer system (the profile corresponding to the differing system). Benefits of such embodiments include quicker system start-up times and faster and more accurate achievement of system target flow rates. For example, a user selects a system target flow rate, the system (calibrated for the agricultural product delivery system profile) has a system lookup database (e.g., at the system lookup module 82) pressure and flow rate match corresponding to the system target flow rate to start delivering the agricultural product. In an example, the calibration database is automatically updated (or an alert is provided advising recalibration) when an error over a specified error threshold is recorded at the pressure difference node 72 or the flow difference node 62 shown in FIG. 4. The specified difference threshold can be about 20%, about 15%, about 10%, about 5%, about 3%, about 2% or less. Stated another way, if a pressure or flow rate difference is identified at the pressure difference node 72 or corresponding flow difference node 62, and the difference rises above a specified difference threshold, the control system 40 conducts a recalibration (with the calibration module 86) or advises that one should be conducted.

FIG. 8 illustrates a method 130 for controlling a delivery of an agricultural product. The method 130 includes inputting a system target flow rate for an agricultural product delivery system, at 132. The agricultural product delivery system includes the cascade control module 60. In an example, the system target flow rate is input at the input module 42 by a user or is pre-programmed, such as for one or more prescriptions indexed to zones of an agricultural field (e.g., in a field map), the agricultural product, the crop, or other factor. The method 130 includes controlling an agricultural product pressure to approach the system target flow rate. For example, at 134 an agricultural product system target pressure is provided that corresponds to the system target flow rate based on at least one system pressure characteristic. In an example, the at least one system pressure characteristic includes the first target pressure, as described herein. At 136, the method 130 includes comparing the agricultural product system target pressure with a measured agricultural product system pressure in a pressure comparison to provide a pressure difference, such as at pressure difference node 72. At 138, a system pressure is adjusted according to the pressure difference to approach the agricultural product system target pressure. As the system pressure is adjusted toward the agricultural product system target pressure, the agricultural product delivery system approaches the system target flow rate.

In an example, the method 130 includes measuring the system flow rate, such as with the flowmeter 80. As described herein, the method includes providing the measured system flow rate to a flow difference node 62 and a system database module. The method 130 includes comparing the measured system flow rate to the system target flow rate to provide a flow rate difference. The flow rate difference is provided to a controller 68 which associates the flow difference with the first target pressure (e.g., a flow based target pressure), which is provided to the pressure difference node 72 or, in an example, a multi-port switch 70. As discussed herein, the first target pressure (updated according to measured changes in flow rate with the flow meter 80) is used by the pressure difference node 72 so the pressure difference node 72 provides a signal to the pressure controller 74 to correspondingly adjust the pressure of the pump 76 (or valve or controller for the pump) according to these measured changes in flow. Stated another way, the method includes controlling the system pressure of the agricultural product based on a nested pressure control loop within a flow measuring control loop, as discussed herein. The flow and pressure instruments and nodes cooperate to provide a method of pressure based flow control for the dispensing system. As measured flow changes, the pressure control provided with the pressure difference node 72 and the pressure controller 74 (and optionally the controller 68) adjusts the pressure of the system to achieve a desired flow rate (e.g. input at the input module 42).

### VARIOUS NOTES & EXAMPLES

Example 1 can include subject matter (such as an apparatus, a method, a means for performing acts, or a machine readable medium including instructions that, when performed by the machine, that can cause the machine to perform acts), such as a method for controlling a delivery of an agricultural product, comprising: measuring an agricultural product flow rate; and controlling the agricultural product flow rate according to flow rate-based control or pressure-based control, wherein a controller is configured to selectively provide both of flow rate-based control and pressure-based control to achieve a system target flow rate, wherein flow-rate based control includes: comparing the measured agricultural product flow rate with a system target flow rate in a flow rate comparison to determine a flow rate difference, adjusting a pump according to the flow rate difference to approach the system target flow rate, and wherein pressure-based control includes: providing an agricultural product system target pressure based on at least one system pressure characteristic, comparing the agricultural product target pressure with a measured agricultural product system pressure in a pressure comparison to determine a pressure difference, and adjusting the pump according to the pressure difference to approach the system target flow rate.

Example 2 can include, or can optionally be combined with the subject matter of Example 1 to optionally comprise controlling the agricultural product flow rate according to flow rate-based control when the measured agricultural product flow rate meets or exceeds a specified threshold flow rate.

Example 3 can include, or can optionally be combined with the subject matter of one or any combination of Examples 1 or 2 to optionally comprise determining the system target flow rate from a system acreage flow rate input based on at least one of a speed of a sprayer boom, a width of the sprayer boom, an agricultural sprayer vehicle speed, a yaw rate of the sprayer boom, and the system acreage flow rate.

Example 4 can include, or can optionally be combined with the subject matter of one or any combination of Examples 1-3 to optionally include wherein the at least one system pressure characteristic includes a flow based target pressure, the method comprising determining the flow based target pressure based on the flow rate difference.

Example 5 can include, or can optionally be combined with the subject matter of one or any combination of Examples 1-4 to optionally comprise providing a system database including a plurality of measured agricultural product system pressures respectively associated with corresponding flow rates for an agricultural sprayer configuration.

Example 6 can include, or can optionally be combined with the subject matter of one or any combination of Examples 1-5 to optionally include wherein the agricultural sprayer configuration is based at least on one of a width of a sprayer boom, a number of nozzles on the sprayer boom, a type of agricultural product dispensed, a field characteristic of an agricultural field, a nozzle type, effective nozzle orifice parameters, control effort driving the pump, and a crop type.

Example 7 can include, or can optionally be combined with the subject matter of one or any combination of Examples 1-6 to optionally comprise logging a target pressure and an associated corresponding flow rate in the system database where the measured agricultural product flow rate is substantially equal to the system target flow rate.

Example 8 can include, or can optionally be combined with the subject matter of one or any combination of Examples 1-7 to optionally comprise using the system database to diagnose a fault in an agricultural product control delivery system configured to deliver the agricultural product according to the method.

Example 9 can include subject matter (such as an apparatus, a method, a means for performing acts, or a machine readable medium including instructions that, when performed by the machine, that can cause the machine to perform acts), such as a system for controlling delivery of an agricultural product, comprising: a flow control loop configured to adjust an agricultural product flow rate to approach a system target flow rate, the flow control loop including: a flow rate error node configured to compare the measured agricultural product flow rate and the system target flow rate and provide a flow rate difference based on the comparison; and a flow rate controller configured to adjust the agricultural product flow rate according to the flow rate comparison to approach the system target flow rate; and a pressure control loop configured to operate in place of the flow control loop, the pressure control loop configured to adjust a pressure of the agricultural product to approach the system target flow rate, the pressure control loop including: a pressure difference node configured to compare a measured agricultural product pressure and a system target pressure and provide a pressure difference based on the comparison; and a pressure controller configured to adjust the agricultural product pressure according to the pressure difference to approach the system target flow rate.

Example 10 can include, or can optionally be combined with the subject matter of one or any combination of Examples 1-9 to optionally comprise a multi-port switch configured to provide the system target pressure based on at least one system pressure characteristic, including a flow based target pressure, a logged target pressure, a standby pressure, and a user input target pressure; a fuzzy controller configured to determine the flow based target pressure according to the flow rate difference; an input selector configured to receive the user input target pressure; a standby pressure module configured to store and provide the standby pressure; and a system lookup module configured to provide the logged target pressure.

Example 11 can include, or can optionally be combined with the subject matter of one or any combination of Examples 1-10 to optionally include wherein the pressure controller and the flow controller are the same.

Example 12 can include, or can optionally be combined with the subject matter of one or any combination of Examples 1-11 to include wherein the system is installed on a vehicle configured to deliver the agricultural product to an agricultural field.

Example 13 can include, or can optionally be combined with the subject matter of one or any combination of Examples 1-12 to optionally comprise a system database module configured to associate the flow based target pressure with a corresponding measured agricultural product flow rate and store the associated flow based target pressure with the corresponding measured agricultural product rate as a logged target pressure-flow rate match. Example 14 can include, or can optionally be combined with the subject matter of one or any combination of Examples 1-13 to optionally include

Example 14 can include, or can optionally be combined with the subject matter of one or any combination of Examples 1-13 to optionally include wherein the system lookup module is configured to provide the logged target pressure as the system target pressure, the logged target pressure corresponding to the system target flow rate based on the logged target pressure-flow rate match.

Example 15 can include, or can optionally be combined with the subject matter of one or any combination of Examples 1-14 to optionally include wherein the system lookup module includes a plurality of system databases, each of the plurality of system databases corresponding to a unique agricultural sprayer configuration.

Example 16 can include, or can optionally be combined with the subject matter of one or any combination of Examples 1-15 to optionally comprise an electronic controller unit (ECU) configured to select the flow control loop and the pressure control loop.

Example 17 can include, or can optionally be combined with the subject matter of one or any combination of Examples 1-16 to optionally include wherein the ECU is configured to select the flow control loop when the agricultural product flow rate meets or exceeds a specified threshold flow rate.

Example 18 can include subject matter (such as an apparatus, a method, a means for performing acts, or a machine readable medium including instructions that, when performed by the machine, that can cause the machine to perform acts), such as a method for performing diagnostics of an agricultural product delivery system, comprising: inputting a system target flow rate for an agricultural product delivery system; controlling an agricultural product pressure to approach the system target flow rate, including: providing an agricultural product system target pressure corresponding to the system target flow rate based on at least one system pressure characteristic, comparing the agricultural product system target pressure with a measured agricultural product system pressure in a pressure comparison to provide a pressure difference, and adjusting a system pressure according to the pressure difference to approach the agricultural product system target pressure; comparing a measured agricultural product system flow rate and the associated measured agricultural product system pressure to an associated flow rate and pressure matching a system database for the agricultural product delivery system; and diagnosing at least one symptom of the agricultural product delivery system based on the comparison of the associated flow rate and pressure match in the system database to the measured agricultural product system flow rate and the associated measured agricultural product system pressure.

Example 19 can include, or can optionally be combined with the subject matter of one or any combination of Examples 1-18 to optionally include wherein the at least one symptom includes at least one of a fouled nozzle, a hose or tube leak, a pump malfunction, and a clogged hose or tube.

Example 20 can include, or can optionally be combined with the subject matter of one or any combination of Examples 1-19 to optionally comprise notifying a user of the diagnosed symptom.

Example 21 can include subject matter (such as an apparatus, a method, a means for performing acts, or a machine readable medium including instructions that, when performed by the machine, that can cause the machine to perform acts), such as a method for calibrating an agricultural product delivery control system, comprising: providing an agricultural product to an agricultural product delivery system, the agricultural product delivery system including a flow control loop configured to adjust a flow rate of the agricultural product and a pressure control loop configured to operate in place of the flow control loop and adjust a pressure of the agricultural product to control the flow rate of the agricultural product; populating a system lookup database with a plurality of pressure and flow rate associations, each association including a specified agricultural product pressure associated with a corresponding measured agricultural product flow rate; and wherein for a specified target flow rate: a corresponding specified agricultural product pressure is retrieved from the populated system lookup database according to the specified target flow rate, and the agricultural product delivery system operates at the specified agricultural product pressure to achieve the specified target flow rate.

Example 22 can include, or can optionally be combined with the subject matter of one or any combination of Examples 1-21 to optionally comprise populating a plurality of system lookup databases, each database corresponding to an agricultural product delivery system profile.

Example 23 can include, or can optionally be combined with the subject matter of one or any combination of Examples 1-22 to optionally include wherein the agricultural product delivery system profile includes at least one of, a nozzle profile, including at least one of a name of the nozzle, and a nozzle size, and an agricultural product characteristic, including at least one of viscosity, density, concentration, and porosity.

Example 24 can include, or can optionally be combined with the subject matter of one or any combination of Examples 1-23 to optionally include wherein populating includes setting the agricultural product delivery system at the specified agricultural product pressure and recording the corresponding measured agricultural product flow rate over a range of specified agricultural product pressures.

Example 25 can include subject matter (such as an apparatus, a method, a means for performing acts, or a machine readable medium including instructions that, when performed by the machine, that can cause the machine to perform acts), such as a method for controlling a delivery of an agricultural product, comprising inputting a system target flow rate for an agricultural product delivery system; and controlling an agricultural product pressure to approach the system target flow rate, including: providing an agricultural product system target pressure corresponding to the system target flow rate based on at least one system pressure characteristic, comparing the agricultural product system target pressure with a measured agricultural product system pressure in a pressure comparison to provide a pressure difference, and adjusting a system pressure according to the pressure difference to approach the agricultural product system target pressure.

Example 26 can include, or can optionally be combined with the subject matter of one or any combination of Examples 1-25 to optionally include receiving the at least one system pressure characteristic from at least one of: an input selector module providing a user input target pressure, a controller providing a flow based target pressure, a standby pressure module providing a standby pressure, and a system lookup module providing a logged target pressure.

Example 27 can include, or can optionally be combined with the subject matter of one or any combination of Examples 1-26 to optionally comprise providing a system database including a plurality of measured agricultural product system pressures respectively associated with corresponding flow rates for an agricultural sprayer configuration.

Example 28 can include, or can optionally be combined with the subject matter of one or any combination of Examples 1-27 to optionally include wherein the agricultural sprayer configuration is based at least on one of a width of a sprayer boom, a number of nozzles on the sprayer boom, a type of agricultural product dispensed, a field characteristic of an agricultural field, a nozzle type, effective nozzle orifice parameters, control effort driving the pump, and a crop type.

Example 29 can include, or can optionally be combined with the subject matter of one or any combination of Examples 1-28 to optionally comprise logging a target pressure and an associated corresponding flow rate in the system database where the measured agricultural product flow rate is substantially equal to the system target flow rate.

Example 30 can include, or can optionally be combined with the subject matter of one or any combination of Examples 1-29 to optionally comprise using the system database to diagnose a fault in an agricultural product control delivery system configured to deliver the agricultural product according to the method.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method for controlling a delivery of an agricultural product, comprising:
inputting a system target flow rate for an agricultural product delivery system; and
controlling an agricultural product pressure to approach the system target flow rate, including:
providing an agricultural product system target pressure corresponding to the system target flow rate based on at least one system pressure characteristic,
comparing the agricultural product system target pressure with a measured agricultural product system pressure in a pressure comparison to provide a pressure difference, and
adjusting a system pressure according to the pressure difference to approach the agricultural product system target pressure.

2. The method of claim 1, further comprising receiving the at least one system pressure characteristic from at least one of:
an input selector module providing a user input target pressure,
a controller providing a flow based target pressure,
a standby pressure module providing a standby pressure, and
a system lookup module providing a logged target pressure.

3. The method of claim 1, further comprising providing a system database including a plurality of measured agricultural product system pressures respectively associated with corresponding flow rates for an agricultural sprayer configuration.

4. The method of claim 3, wherein the agricultural sprayer configuration is based at least on one of a width of a sprayer boom, a number of nozzles on the sprayer boom, a type of agricultural product dispensed, a field characteristic of an agricultural field, a nozzle type, effective nozzle orifice parameters, control effort driving the pump, and a crop type.

5. The method of claim 3, further comprising logging a target pressure and an associated corresponding flow rate in the system database where the measured agricultural product flow rate is substantially equal to the system target flow rate.

6. The method of claim 3, further comprising using the system database to diagnose a fault in an agricultural product control delivery system configured to deliver the agricultural product according to the method.

7. A method for controlling a delivery of an agricultural product, comprising:
measuring an agricultural product flow rate; and
controlling the agricultural product flow rate according to flow rate-based control or pressure-based control, wherein a controller is configured to selectively provide both of flow rate-based control and pressure-based control to achieve a system target flow rate,
wherein flow-rate based control includes:
comparing the measured agricultural product flow rate with a system target flow rate in a flow rate comparison to determine a flow rate difference,
adjusting a pump according to the flow rate difference to approach the system target flow rate, and
wherein pressure-based control includes:
providing an agricultural product system target pressure based on at least one system pressure characteristic,
comparing the agricultural product target pressure with a measured agricultural product system pressure in a pressure comparison to determine a pressure difference, and
adjusting the pump according to the pressure difference to approach the system target flow rate.

8. The method of claim 7, comprising controlling the agricultural product flow rate according to flow rate-based control when the measured agricultural product flow rate meets or exceeds a specified threshold flow rate.

9. The method of claim 7, comprising determining the system target flow rate from a system acreage flow rate input based on at least one of a speed of a sprayer boom, a width of the sprayer boom, an agricultural sprayer vehicle speed, a yaw rate of the sprayer boom, and the system acreage flow rate.

10. The method of claim 7, wherein the at least one system pressure characteristic includes a flow based target pressure, the method comprising determining the flow based target pressure based on the flow rate difference.

11. The method of claim 7, comprising providing a system database including a plurality of measured agricultural product system pressures respectively associated with corresponding flow rates for an agricultural sprayer configuration.

12. The method of claim 11, wherein the agricultural sprayer configuration is based at least on one of a width of a sprayer boom, a number of nozzles on the sprayer boom, a type of agricultural product dispensed, a field characteristic of an agricultural field, a nozzle type, effective nozzle orifice parameters, control effort driving the pump, and a crop type.

13. The method of claim 11, comprising logging a target pressure and an associated corresponding flow rate in the system database where the measured agricultural product flow rate is substantially equal to the system target flow rate.

14. The method of claim 11, comprising using the system database to diagnose a fault in an agricultural product control delivery system configured to deliver the agricultural product according to the method.

15. A system of controlling delivery of an agricultural product, comprising:
a flow control loop configured to adjust an agricultural product flow rate to approach a system target flow rate, the flow control loop including:
a flow rate error node configured to compare the measured agricultural product flow rate and the system target flow rate and provide a flow rate difference based on the comparison; and
a flow rate controller configured to adjust the agricultural product flow rate according to the flow rate comparison to approach the system target flow rate; and
a pressure control loop configured to operate in place of the flow control loop, the pressure control loop configured to adjust a pressure of the agricultural product to approach the system target flow rate, the pressure control loop including:
a pressure difference node configured to compare a measured agricultural product pressure and a system target pressure and provide a pressure difference based on the comparison; and
a pressure controller configured to adjust the agricultural product pressure according to the pressure difference to approach the system target flow rate.

16. The system of claim 15, further comprising:
a multi-port switch configured to provide the system target pressure based on at least one system pressure characteristic, including a flow based target pressure, a logged target pressure, a standby pressure, and a user input target pressure;
a fuzzy controller configured to determine the flow based target pressure according to the flow rate difference;
an input selector configured to receive the user input target pressure;
a standby pressure module configured to store and provide the standby pressure; and
a system lookup module configured to provide the logged target pressure.

17. The system of claim 15, wherein the pressure controller and the flow controller are the same.

18. The system of claim 15, wherein the system is installed on a vehicle configured to deliver the agricultural product to an agricultural field.

19. The system of claim 15, comprising a system database module configured to associate the flow based target pressure with a corresponding measured agricultural product flow rate and store the associated flow based target pressure with the corresponding measured agricultural product rate as a logged target pressure-flow rate match.

20. The system of claim 19, wherein the system lookup module is configured to provide the logged target pressure as the system target pressure, the logged target pressure corresponding to the system target flow rate based on the logged target pressure-flow rate match.

21. The system of claim 19, wherein the system lookup module includes a plurality of system databases, each of the plurality of system databases corresponding to a unique agricultural sprayer configuration.

22. The system of claim 15, comprising an electronic controller unit (ECU) configured to select the flow control loop and the pressure control loop.

23. The system of claim 22, wherein the ECU is configured to select the flow control loop when the agricultural product flow rate meets or exceeds a specified threshold flow rate.

24. A method for performing diagnostics of an agricultural product delivery system, comprising:
inputting a system target flow rate for an agricultural product delivery system;
controlling an agricultural product pressure to approach the system target flow rate, including:
providing an agricultural product system target pressure corresponding to the system target flow rate based on at least one system pressure characteristic,
comparing the agricultural product system target pressure with a measured agricultural product system pressure in a pressure comparison to provide a pressure difference, and
adjusting a system pressure according to the pressure difference to approach the agricultural product system target pressure;
comparing a measured agricultural product system flow rate and the associated measured agricultural product system pressure to an associated flow rate and pressure matching a system database for the agricultural product delivery system; and
diagnosing at least one symptom of the agricultural product delivery system based on the comparison of the associated flow rate and pressure match in the system database to the measured agricultural product system flow rate and the associated measured agricultural product system pressure.

25. The method of claim 24, wherein the at least one symptom includes at least one of a fouled nozzle, a hose or tube leak, a pump malfunction, and a clogged hose or tube.

26. The method of claim 24, comprising notifying a user of the diagnosed symptom.

27. A method for calibrating an agricultural product delivery control system, comprising:
providing an agricultural product to an agricultural product delivery system, the agricultural product delivery system including a flow control loop configured to adjust a flow rate of the agricultural product and a pressure control loop configured to operate in place of the flow control loop and adjust a pressure of the agricultural product to control the flow rate of the agricultural product;
populating a system lookup database with a plurality of pressure and flow rate associations, each association including a specified agricultural product pressure associated with a corresponding measured agricultural product flow rate; and
wherein for a specified target flow rate:
a corresponding specified agricultural product pressure is retrieved from the populated system lookup database according to the specified target flow rate, and
the agricultural product delivery system operates at the specified agricultural product pressure to achieve the specified target flow rate.

28. The method of claim 27, further comprising populating a plurality of system lookup databases, each database corresponding to an agricultural product delivery system profile.

29. The method of claim 28, wherein the agricultural product delivery system profile includes at least one of, a nozzle profile, including at least one of a name of the nozzle, and a nozzle size, and an agricultural product characteristic, including at least one of viscosity, density, concentration, and porosity.

30. The method of claim 27, wherein populating includes setting the agricultural product delivery system at the specified agricultural product pressure and recording the corresponding measured agricultural product flow rate over a range of specified agricultural product pressures.
